(19) United States
(12) Patent Application Publication
(10) Pub. No.: US 2023/0168657 A1
(43) Pub. Date: Jun. 1, 2023

(54) METHOD FOR FACILITIES PREDICTIVE MAINTENANCE BASED ON EMBEDDING ANALYSIS

(71) Applicant: ULALA LAB. INC, Anyang-si (KR)

(72) Inventor: Hak Ju KANG, Gunpo-si (KR)

(21) Appl. No.: 17/972,254

(22) Filed: Oct. 24, 2022

(30) Foreign Application Priority Data
Nov. 26, 2021 (KR) 10-2021-0165661
Nov. 26, 2021 (KR) 1020210165661
Feb. 21, 2022 (KR) 10-2022-0021944
Feb. 21, 2022 (KR) 1020220021944

(51) Int. Cl. G05B 19/406; G05B 23/02

(52) U.S. Cl. CPC G05B 19/406; G05B 23/0224; G05B 2219/32234; G05B 2223/02

(57) ABSTRACT

Provided is an embedding analysis-based facility predictive maintenance method performed by a server, including (a) collecting time-series operation data of at least one machine; (b) deriving abnormal state information to determine whether the collected time-series operation data deviates from a time-series threshold, deriving an embedding result pattern through embedding analysis on the collected time-series operation data, and mapping the embedding result pattern and the abnormal state information; (c) building an abnormal pattern analysis model by performing machine learning on each mapped information and analyzing whether the embedding result pattern indicates abnormality or normality; and (d) when new time-series operation data is collected, applying the new time-series operation data to the abnormal pattern analysis model to derive current state information and future prediction state information.

### CROSS-REFERENCE TO RELATED APPLICATION

This application claims the benefit of Korean Patent Application No. 10-2022-0021944 filed on Feb. 21, 2022 and Korean Patent Application No. 10-2021-0165661 filed on Nov. 26, 2021, in the Korean Intellectual Property Office, the entire disclosure of which is incorporated herein by reference for all purposes.

### BACKGROUND

### 1. Field of the Invention

One or more example embodiments relate to an embedding analysis-based facility predictive maintenance method, and more particularly, to a technology to achieve facility predictive maintenance by performing time series data analysis and embedding analysis and learning on the operation information of facilities collected from IoT sensors.

### 2. Description of the Related Art

In recent years, with the advancement of sensor technology, the 4th industrial revolution technology incorporating the IoT sensor is emerging, and in particular, the technology related to the smart factory is in the spotlight.

A smart factory is a holistic technology that enables connecting and easily managing the machines and facilities of a factory, and one of the essential elements in building a smart factory is to determine whether the facilities or machines are operating normally within the smart factory.

Factory systems according to a related art, in order to predict a malfunction of a facility or machine, have determined that a specific error has occurred when data deviating from a threshold among collected data is detected through a sensor with a set threshold.

However, the smart factory grasps the operating state of the machine through the IoT sensor and does not simply depend on a preset threshold for the normal operation state, and may also perform maintenance in consideration of the information on the current operating state of the facility or machine and the information about the operating state to be changed in the future.

In addition, the recent smart factory site is changing so that a machine learning model or AI replaces the judgment and judgment criteria for the threshold or operating state that have been previously judged by humans to become mainstream.

### SUMMARY

The present disclosure has been made to solve the issues of the prior art described above, and an object of the present disclosure is to accurately predict and detect the current or future facility state by performing embedding analysis on the operation data of the machine collected from the IoT sensor, and by performing machine learning on the embedding analysis result.

In addition, the present disclosure aims to build a machine learning model that learns and predicts the current state of a facility or machine and the state that will change in the near future based on time-series operation data and time-series thresholds.

The issues to be solved by the present disclosure are not limited to the issues mentioned above, and other issues not mentioned will be clearly understood from the following description.

As a technical means for achieving the technical objects, according to an aspect of the present disclosure, there is provided an embedding analysis-based facility predictive maintenance method performed by a server, including (a) collecting time-series operation data of at least one machine; (b) deriving abnormal state information to determine whether the collected time-series operation data deviates from a time-series threshold, deriving an embedding result pattern through embedding analysis on the collected time-series operation data, and mapping the embedding result pattern and the abnormal state information; (c) building an abnormal pattern analysis model by performing machine learning on each mapped information and analyzing whether the embedding result pattern indicates abnormality or normality; and (d) when new time-series operation data is collected, applying the new time-series operation data to the abnormal pattern analysis model to derive current state information and future prediction state information.

In addition, the (a) may include (a-1) collecting operation data when the machine operates and performs a process of manufacturing a specified product; (a-2) converting the operation data into frequency data by performing FFT analysis; and (a-3) dividing the collected operation data by using time required for the machine to manufacture one product as one cycle, and collecting the time-series operation data by mapping the divided operation data on a time domain having a length corresponding to the one cycle.

In addition, when there are a plurality of measurement sensors installed in the machine, the operation data may be data related to an operation of the machine collected by each of a plurality of channels for a preset period from an IoT sensor.

In addition, the (b) may include (b-1) deriving upper and lower limits of the time-series threshold by learning time-series operation data from which actual state information is generated and time-series operation data indicating a normal state; (b-2) detecting abnormal state information of real-time time-series operation data according to whether the collected time-series operation data deviates from the upper and lower limits of the time-series threshold; (b-3) deriving the embedding result pattern by embedding analysis of the time-series operation data; and (b-4) matching and storing the abnormal state information, the embedding result pattern, and the actual state information of the time-series operation data, wherein the actual state information is information indicating whether there is a machine error and whether a product manufactured by the machine is defective, which is any one of information indicating machine error and product defect, information indicating machine error and product normality, and information indicating machine normality and product defect.

In addition, the embedding result pattern may be expressed as a graph consisting of four quadrants, and in the graph, any one of an X-axis and a Y-axis may indicate a presence or absence of an abnormal state, the other may indicate a degree of the abnormal state, and a result value of FFT analysis of the operation data may be displayed as dots of different colors for each three-phase channel.

In addition, the dots may include first group dots distributed sporadically over a preset interval and second group dots distributed close to each other within the preset interval or less, and the method may detect the presence or absence of the abnormal state and the degree of the abnormal state based on which quadrant the second group dots are located.

In addition, the (b-3) may include matching and storing the abnormal state information, the embedding result pattern, and the actual state information of a specific machine from a normal state to an abnormal state or until returning to the normal state after a failure state occurs, and performing machine learning.

In addition, the (b) may further include predicting a future embedding result pattern from the embedding result pattern by the time-series operation data collected in real-time based on the result of the machine learning performed in the (b-3).

In addition, the future embedding result pattern may be related to a movement direction, movement distance, and movement time of each dot group forming the current embedding result pattern.

In addition, the future embedding result pattern may be related to a presence or absence of a failure or abnormal state, and time taken until normal operation after the failure or abnormal state occurs.

In addition, the (b) may further include updating the time-series threshold as the operation data is collected and accumulated in real-time.

In addition, the method may further include (e) providing a manager terminal with prediction information on whether an operating state of the machine will change from a normal state to an abnormal state or a prediction information on whether the operating state of the machine will change from the abnormal state to the normal state and the future prediction state information and actual state information including information on a type of failure and time required for each state transition.

According to another aspect, there is provided a server performing an embedding analysis-based facility predictive maintenance method, including a memory in which a program for performing an embedding analysis-based facility predictive maintenance method is stored; and a processor for executing the program, wherein the method includes (a) collecting time-series operation data of at least one machine; (b) deriving abnormal state information to determine whether the collected time-series operation data deviates from a time-series threshold, deriving an embedding result pattern through embedding analysis on the collected time-series operation data, and mapping the embedding result pattern and the abnormal state information; (c) building an abnormal pattern analysis model by performing machine learning on each mapped information and analyzing whether the embedding result pattern indicates abnormality or normality; and (d) when new time-series operation data is collected, applying the new time-series operation data to the abnormal pattern analysis model to derive current state information and future prediction state information.

Additional aspects of example embodiments will be set forth in part in the description which follows and, in part, will be apparent from the description, or may be learned by practice of the disclosure.

According to example embodiments, by matching the results of embedding analysis with the analysis results of time-series operation data, inferring the meaning of the results of embedding analysis, and machine learning these analysis results, it is possible to accurately detect machine defects or product defects that could not be found in methods according to a related art.

Accordingly, the facilities or machines in the smart factory may produce products of proven quality by producing products more precisely than the existing methods, and precise predictive maintenance is possible because it is possible to check not only the presence or absence of abnormality of the product, but also the operation status of the relevant facilities and machines.

Furthermore, a predictive maintenance method that may respond more flexibly to unexpected situations may be provided by the machine learning model predicting the machine's operation state that will change in the near future based on the current operation state of facilities and machines and the collected data.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a structural diagram of an embedding analysis-based facility predictive maintenance system according to an example embodiment of the present disclosure;

FIG. 2 is a block diagram illustrating an internal configuration of a server according to an example embodiment of the present disclosure;

FIG. 3A is an exemplary diagram of a graph illustrating RAW data, time-series operation data, and an embedding result pattern according to an example embodiment of the present disclosure;

FIG. 3B is an exemplary diagram illustrating a mapping between time-series operation data and an embedding result pattern according to an example embodiment of the present disclosure;

FIG. 4A is an exemplary diagram of an embedding result pattern and first group dots, second group dots, and third group dots according to an example embodiment of the present disclosure;

FIG. 4B is an exemplary diagram illustrating a presence or absence of an abnormal state and a state degree mapping between time-series operation data and an embedding result pattern according to an example embodiment of the present disclosure;

FIG. 5 is an exemplary diagram illustrating a performance of embedding analysis-based facility predictive maintenance according to an example embodiment of the present disclosure; and

FIG. 6 is a flowchart illustrating a performance sequence of embedding analysis-based facility predictive maintenance according to an example embodiment of the present disclosure.

### DETAILED DESCRIPTION

Hereinafter, example embodiments of the present disclosure will be described in detail with reference to the accompanying drawings so that those skilled in the art may easily carry out the present disclosure. However, the present disclosure may be embodied in several different forms and is not limited to the example embodiments described herein. In addition, in order to clearly explain the present disclosure in the drawings, parts irrelevant to the description are omitted, and similar reference numerals are attached to similar parts throughout the specification.

Throughout the specification, when it is mentioned that one part is “connected” to another part, it may include not only the case of being “directly connected” but also the case of being “electrically connected” with other element interposed therebetween. Futther, when a part “includes” a certain component, it means that other components may be further included, rather than excluding other components, unless otherwise stated.

In this specification, a “part” includes a unit realized by hardware, a unit realized by software, and a unit realized using both. In addition, one unit may be implemented using two or more hardware, and two or more units may be implemented by one hardware. Meanwhile, “—part” is not limited to software or hardware, and “—part” may be configured to be in an addressable storage medium or may be configured to reproduce one or more processors. Thus, as an example, “—part” refers to components such as software components, object-oriented software components, class components and task components, processes, functions, properties, procedures, subroutines, segments of program code, drivers, firmware, microcode, circuitry, data, databases, data structures, tables, arrays and variables. Functions provided within components and “—parts” may be combined into a smaller number of components and “—parts” or further divided into additional components and “—parts”. In addition, components and “—parts” may be implemented to play one or more CPUs in a device or secure multimedia card.

A “terminal” referred to below may be implemented as a computer or portable terminal that may access a server or other terminal through a network. Here, a computer may include, for example, a laptop, desktop, laptop, VR HMD (e.g., HTC VIVE, Oculus Rift, GearVR, DayDream, PSVR, etc.) equipped with a WEB Browser), etc. Here, VR HMD includes all standalone models (e.g., Deepon, PICO, etc.) implemented independently of PC (e.g., HTC VIVE, Oculus Rift, FOVE, Deepon, etc.), mobile (e.g., GearVR, DayDream, Storm Horse, Google Cardboard, etc.), and console (PSVR). A portable terminal is, for example, a wireless communication device that guarantees portability and mobility, and includes not only a smart phone, a tablet PC, a wearable device, but also various devices equipped with communication modules such as Bluetooth (BLE, Bluetooth Low Energy), NFC, RFID, ultrasonic, infrared, Wi-Fi, Li-Fi, etc. In addition, the term “network” refers to a connection structure in which information may be exchanged between each node, such as terminals and servers, and includes a local area network (LAN), a wide area network (WAN), and the Internet (WWW: World Wide Web), wired and wireless data networks, telephone networks, wired and wireless television networks, etc. Examples of wireless data communication networks include 3G, 4G, 5G, 3rd generation partnership project (3GPP), long term evolution (LTE), world interoperability for microwave access (WIMAX), Wi-Fi, Bluetooth communication, infrared communication, ultrasound communication, visible light communication (VLC), LiFi, and the like, but are not limited thereto.

Hereinafter, “product” refers to a part produced in a factory or a sub-component of the part, and refers to an object manufactured or produced by one machine.

A system according to an example embodiment of the present disclosure is a system that provides a smart factory service, and by monitoring the operation status of machines or facilities in the smart factory and when a malfunction is expected or actually occurs, the system notifies the manager, so that the management of machines and facilities in the smart factory may be efficiently provided.

In particular, by providing Internet of Things (IOT) technology-based service through an IoT sensor 200 and a machine learning model, since it is connected to the communication network and provides the collected information to a server 100, it is possible to shorten the process of inspecting the machine for a problem by the factory manager one by one, and by performing machine learning on the data measured from the IoT sensor 200, it is possible to provide the server 100 that predicts threshold data and the current and future conditions of facility to determine whether there is a machine abnormality or product abnormality more precisely.

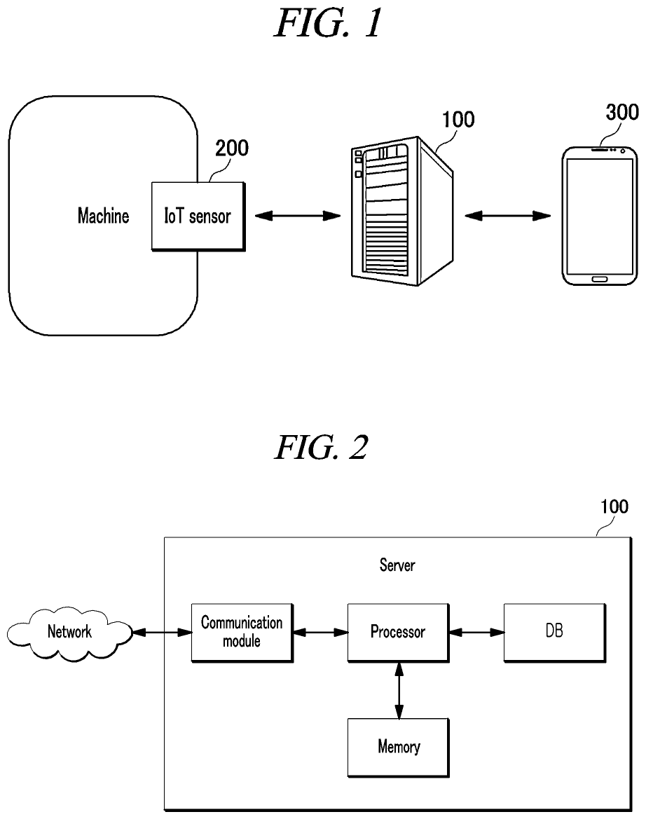

Referring to FIG. 1, an embedding analysis-based facility predictive maintenance system of an example embodiment of the present disclosure includes the server 100, the IoT sensor 200 installed inside or outside the machine or facility in the factory where the product is produced or within a preset distance and a manager terminal 300.

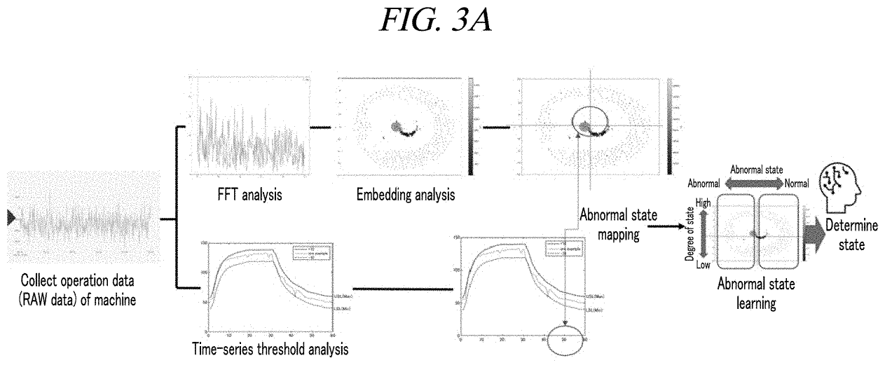

As shown in FIG. 2, the server 100 according to an example embodiment of the present disclosure may be configured to include a memory in which a program (or application) for performing an embedding analysis-based facility predictive maintenance method is stored and a processor executing the program. Here, the processor may perform various functions according to the execution of the program stored in the memory.

The IoT sensor 200 according to an example embodiment of the present disclosure is installed inside or outside a machine or facility in a factory where a product is produced or within a preset distance, and may collect operation data 400 generated in the process of a machine or facility producing a product.

Here, when the current supplied to the machine uses three-phase power, the operation data 400 may be collected for each three-phase channel from the IoT sensor 200 for a preset period.

In addition, according to another example embodiment of the present disclosure, the IoT sensor 200 may collect a plurality of homogeneous or heterogeneous data through a plurality of channels. For example, in the case of a machine powered by three-phase power, data may be collected with a three-phase channel, but data may be collected for three or more-phase channels, for example, four or five channels.

In addition to current sensors that collect current data, temperature/humidity sensors, vibration/noise sensors, touch pressure sensors, microphones, camera proximity sensors, illuminance sensors, color sensors, acceleration sensors, geomagnetism/gyroscopes and IR motion/body temperature sensors may be included.

Next, the manager terminal 300 according to an example embodiment of the present disclosure may refer to a terminal assigned to a manager in charge of any one process among line facility in a factory, and a terminal assigned to a product production line manager or a factory manager, and may include a tablet PC, a PDA, a smart phone, and the like.

Hereinafter, a process of performing an embedding analysis-based facility predictive maintenance method according to an example embodiment of the present disclosure will be described.

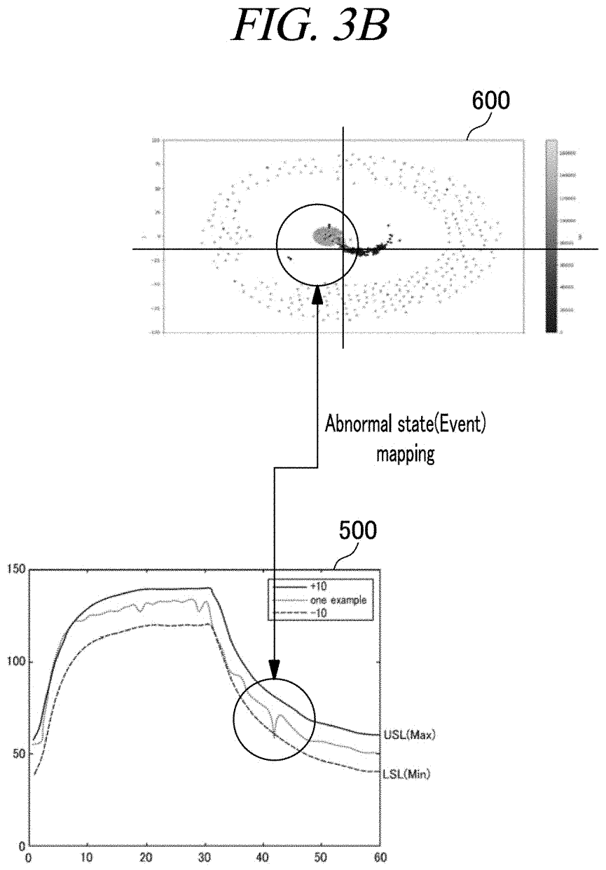

First, referring to FIG. 3A, the server 100 collects time-series operation data 500 of at least one machine from the IoT sensor 200 installed in a facility or machine in a smart factory.

Here, the server 100 collects the operation data 400 when the corresponding machine operates and performs the process of manufacturing the specified product, and the collected operation data 400 may be analyzed by a fast fourier transform (FFT) method and converted into frequency data.

The collection of the operation data 400 may be continuously collected by setting the time required for the machine or facility to be observed to manufacture one finished product or part as one cycle, and the cycle may be changed by the manager terminal 300 or a machine learning model to be described later.

Thereafter, the server 100 divides the collected operation data 400 according to the above-described cycle, and maps the divided operation data 400 on a time domain having a length corresponding to one cycle, so that the operation data 400 in the RAW data state received from the IoT sensor 200 may be converted into time-series operation data 500 and collected.

Next, the server 100 derives abnormal state information that determines whether the collected time-series operation data 500 deviates from the time-series threshold, derives an embedding result pattern 600 through embedding analysis on the collected time-series operation data 500 and performs a process of mapping the embedding result pattern 600 and the abnormal state information.

Here, the time-series threshold may refer to upper and lower limits of the time-series threshold detected and learned by the server 100 in advance by learning the time-series operation data 500 from which RAW data and actual state information are generated, the time-series operation data 500 indicating normal state, and actual state information to be described later. The actual state information according to an example embodiment of the present disclosure includes information indicating whether there is a machine error and whether a product manufactured by the machine is defective, which is any one of information indicating machine error and product defect, information indicating machine error and product normality, and information indicating machine normality and product defect, which may be preset prior to the implementation of the present disclosure. The machine error information may include various error information such as a motor error, a bearing error, and a conveyor belt error.

Here, the upper and lower limits of the time-series threshold are set in consideration of the collected time-series operation data 500, RAW data, and actual state information, wherein the upper limit at which the machine or facility to be observed normally operates may be set as the upper limit of the time-series threshold, and the lower limit at which the machine or facility to be observed normally operates may be set as the lower limit of the time-series threshold.

Here, according to another example embodiment of the present disclosure, the actual state information may be set by the manager terminal 300 and provided to the server 100, or may be changed or preset by a machine learning model to be described later.

For example, the actual state information may be stored by matching information (actual state information) on whether the specific time-series operation data 500 is “bearing defect” or “motor voltage defective”, and when the actual state information-embedding result pattern 600-time-series operation data 500 is matched and stored, information on the movement range, movement distance, and movement time among the three phases of the operation data 400 RTS may be stored.

Next, the server 100 may detect abnormal state information of the real-time time-series operation data 500, according to whether the time-series operation data 500 collected from the IoT sensor 200 deviates from the upper and lower limits of the time-series threshold.

Referring to FIG. 3A, the abnormal state information includes the amount of change of the time-series operation data 500 per unit time of the time-series operation data 500 and the time-series threshold, and the server 100 may recognize that an abnormality occurs in the facility or machine to be observed through the abnormal state information, and may derive the embedding result pattern 600 by FFTing the time-series RAW data and the embedding analyzing.

Here, according to an example embodiment of the present disclosure, since the time-series threshold is something that may be calculated by a machine learning model, while machine learning for time-series thresholds is performed based on RAW data without FFT processing, time-series operation data obtained by FFT processing of RAW data may be utilized in the embedding analysis process.

Therefore, in the present disclosure, the process of performing machine learning on the threshold by collecting RAW data and the process of collecting RAW data and performing the embedding analysis after FFT processing may be performed simultaneously in parallel.

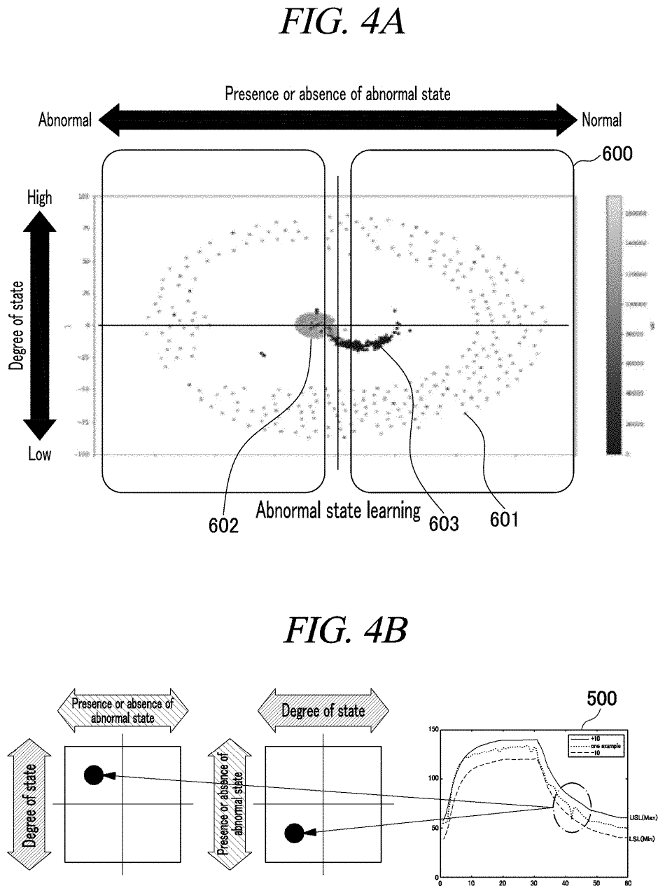

Embedding analysis is a conventional technique, and is a useful technique for visualizing correlations between data. In other words, when each data is vectorized, a plurality of dimensions of each vector are converted into a two-dimensional vector through embedding analysis, and then mapped on a two-dimensional graph, a graph shown in FIG. 4A may be provided.

The present disclosure performs embedding analysis of the time-series operation data 500 obtained by FFT analysis of the operation data 400, and indicates the result value as an embedding result pattern 600, the Y-axis corresponding to the state degree among the axes constituting the embedding result pattern 600 may vary depending on where the sampling range of the FFT analysis result value is designated, and a plurality of dots displayed on the embedding result pattern 600 are also changed to be distinguished.

In particular, the plurality of dots displayed on the embedding result pattern 600 may be displayed in different colors that match according to a preset value, and the dots that show less than a preset density and appear sparsely are either an error value or a value whose status cannot be confirmed, and are assumed to be meaningless for analysis.

On the other hand, a cluster showing more than a preset density and showing a plurality of dots in the form of a set is determined as a meaningful data value from which state information may be determined, and accordingly, the server 100 analyzes the dot cluster set position of the same color as the color of the corresponding cluster.

However, since it is not possible to know what the above data means only with the embedding analysis result, the present disclosure uses a time-series threshold to match the abnormal state information detected by determining whether the operation data 400 deviates from the threshold and the embedding result pattern 600, so that it may be seen whether the embedding result pattern 600 indicates an abnormal state or a normal state.

In addition, by matching and storing the embedding result pattern 600 and the abnormal state information detected using the time-series threshold, and the actual state information (information about what error occurred in the actual machine or product), it is possible to determine what actual state the embedding result pattern 600 means. In addition, it is possible to collect and machine-learning a lot of training data related to the embedding result pattern 600, abnormal state information, and actual state information. To explain in more detail with reference to FIG. 3B, the server 100 matches and stores the abnormal state information, the movement of the above-mentioned dot cluster in the embedding result pattern 600, and the actual state information of a machine to be observed from a normal state to an abnormal state or until returning to a normal state after a failure state occurs through embedding analysis, and performs machine learning (e.g., unsupervised learning) on the matched and stored data.

Referring to FIG. 4A, the embedding result pattern 600 may be expressed as a graph consisting of four quadrants, in which one of the X-axis and Y-axis indicates the presence or absence of an abnormal state, and the other one may indicate the degree of the abnormal state. In addition, a result value of FFT analysis of the operation data 400 may be displayed as dots of different colors for each three-phase channel. Referring to FIG. 4B, it means that the x-axis and the y-axis on the graph of the embedding result pattern 600 may be changed flexibly. In other words, since the x-axis and y-axis of the graph are not always fixed values, it is possible to clearly know which axis indicates the state degree and which axis indicates the presence or absence of an abnormal state by mapping with error information through the time-series threshold.

For example, in the case of the left graph of FIG. 4B, although the set of dots is located in the fourth quadrant, the x-axis may be determined as the axis indicating the presence or absence of an abnormal state if the comparison result with the time-series threshold indicates normal and the degree of normal state is high. Alternatively, in the case of the middle graph of FIG. 4B, although the set of dots is located in the third quadrant, if the comparison result with the time-series threshold indicates normal, but the degree of state is low due to the appearance of abnormal symptoms, it may be determined that the y-axis is the axis indicating the presence or absence of an abnormal state.

Here, each dot displayed on the embedding result pattern 600 may determine and display the dots distributed sporadically over a preset interval as first group dots and the dots distributed close to each other within the preset interval or less as second group dots, and the server may detect the presence or absence of the abnormal state and the degree of the abnormal state based on which quadrant the second group dots corresponding to valid data are located.

Additionally, according to the type of operation data 400 (other than three-phase current data), third group dots 603 may also be displayed on the embedding result pattern 600, and according to a further example embodiment of the present disclosure, the server 100 may also perform prediction of the facility to be observed according to the distribution, distance, and movement direction between each group dots according to the result of the machine learning execution.

The analysis requirement in the further example embodiment may include which data value among R, S, and T three phases in the operation data 400 corresponds to a specific dot group corresponding to the embedding result pattern 600, and whether the entire dot group moves, and the movement distance (range) value of each dot group and the movement time, and in addition, it may include a specific facility or a specific state of a specific facility (e.g., when a drying facility is installed in a high humidity state).

In other words, the abnormal pattern analysis model according to an example embodiment of the present disclosure may know the actual state information corresponding to each embedding result pattern according to the result of machine learning, and may also know the embedding result pattern expected after a predetermined time has elapsed from a specific embedding result pattern. Therefore, just by referring to the shape, movement direction, movement distance, and movement time of each dot group constituting the current embedding result pattern 600 and the dot group of the embedding result pattern 600 after a few days, it is possible to predict whether the facility is currently in a normal or abnormal state, or what state it will change to later.

Additionally, in the above-described process, as the server 100 collects and accumulates the operation data 400 from the IoT sensor 200 in real time, it is also possible to accumulate more than a preset value or update the time-series threshold every preset cycle.

Therefore, the server 100 builds an abnormal pattern analysis model by performing machine learning for each mapped information, and analyzing whether the embedding result pattern 600 indicates abnormality or normality, and when the new time-series operation data 500 is collected, the new time-series operation data 500 may be applied to the abnormal pattern analysis model to derive current state information and future prediction state information.

The machine learning model according to an example embodiment of the present disclosure includes the abnormal pattern analysis model as described above, and in the machine learning process, and after the model is completed through the first supervised learning, the collected information is automatically learned by unsupervised learning, so that unsupervised learning and supervised learning may be combined, and as input data used for learning, operation data 400, time-series operation data 500, time-series threshold, and information about the location and density of dot groups in the embedding result pattern 600 may be included, and actual state information that is mapped or matched with at least one of the input data may be included as the result data.

Therefore, the server 100 may provide to a manager terminal 300, derived information, prediction information on whether an operating state of the machine will change from a normal state to an abnormal state, or a prediction information on whether an operating state of the machine will change from an abnormal state to a normal state and the future prediction state information and actual state information including information on a type of failure and time required for each state transition.

Hereinafter, an example of performing predictive maintenance of facility or machines according to the embedding analysis-based facility predictive maintenance method according to an example embodiment of the present disclosure will be described.

First, it is assumed that the machine in which the IoT sensor 200 is installed was observed from August 16 to October 29.

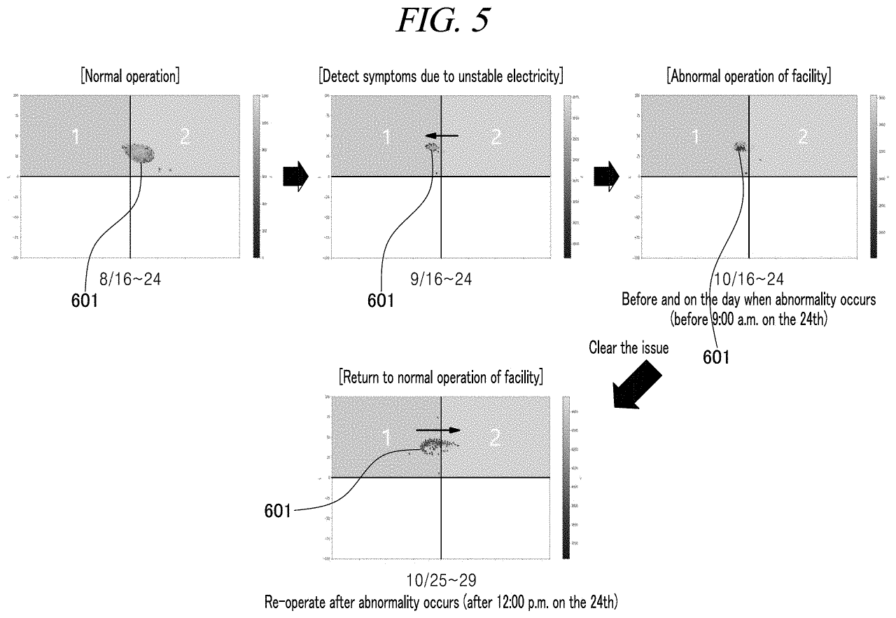

Referring to the operation data 400 collected from August 16 to 24 with reference to FIG. 5, in the embedding result pattern 600 calculated from the operation data 400, a dot group is indicated in the second region (assumed as the second quadrant) as shown.

The abnormal pattern analysis model according to an example embodiment of the present disclosure maps the operation data 400 collected from August 16 to 24, the time-series operation data 500 and the embedding result pattern 600, and when it is determined that the object to be observed has operated normally during the corresponding period, the mapping may be learned as a normally operated mapping.

In addition, if it is assumed to be an abnormal pattern analysis model that has already been learned, the operation data 400 collected from August 16 to 24 may immediately determine that the machine is operating normally.

Next, referring to the embedding result pattern 600 observed between September 16 and September 24, it is observed that the dot group moves from the second region to the first region (assumed as the first quadrant).

Here, the abnormal pattern analysis model maps the operation data 400 collected from September 16 to 24, the time-series operation data 500 and the embedding result pattern 600, and by matching information on whether there is a machine error and whether the product manufactured by the machine is defective with actual state information which is any one of information indicating machine error and product defect, information indicating machine error and product normality, and information indicating machine normality and product defect, the mapping may be learned as the occurrence of symptoms due to unstable electricity while the object to be observed is operating during the corresponding period.

In addition, if it is assumed that it is an abnormal pattern analysis model that has already been learned, the operation data 400 collected from September 16 to 24 may immediately determine the mapping as a symptom caused by unstable electricity while the object to be observed is operating during the corresponding period.

Next, referring to the embedding result pattern 600 observed between October 16 and September 24, it is observed that the movement of the dot group more clearly moved from the second region to the first region.

In this case, the more distinct movement of the dot group may be determined in consideration of the movement distance of the dot group, the period, and the color of the dot group, rather than simply determined based on the movement distance and period of the dot.

In this case, the abnormal pattern analysis model maps the operation data 400 collected from October 16 to 24, the time-series operation data 500 and the embedding result pattern 600, and the correlation between each mapping with the previous mapping, i.e., the operation data 400 detected between September 16 and 24, the time-series operation data 500 and the embedding result pattern 600 mapping, is considered.

In other words, by correlating and learning the mapping of September and October where the abnormal symptom was first detected, it may be learned that the mapping in October is the mapping that appears after the mapping in September (the observed subject developed symptoms due to unstable electricity while in operation during the period).

Here, the server 100 according to an example embodiment of the present disclosure may provide information on a period from the mapping observed from September 16 to 24 until the mapping observed from October 16 to 24 is observed to the manager terminal 300, in both cases when it is determined that the first abnormal symptom appears in September, and when the abnormal symptom appears and continues until mapping in October.

In addition, when the operation data 400 determined to be the same data as the operation data 400 observed between September 16 and 24 or similar data because the distribution shape and distribution position of the dot group are located within a preset range is first searched, according to the learning, it is possible to provide the manager terminal 300 with a prediction period of how long it will take before (in this case, one month).

If it is assumed that the cause of the abnormal symptom occurring in the facility to be observed is resolved after October 24 and on October 25, the dot group is moved from the first quadrant to the second quadrant as shown.

In this case as well, the abnormal pattern analysis model maps the operation data 400 collected from October 25 to 29, the time-series operation data 500 and the embedding result pattern 600, and learning may be performed in consideration of the correlation between the September mapping and October mapping, corresponding to the previous mapping, and the mapping after October 25.

Therefore, when the corresponding mapping is completed, the abnormal pattern analysis model may recognize that when the operation data 400 that appears between August 16 and 24 and the operation data 400 determined to be similar as described above are detected, there is a high probability that a defect (in this case, detecting symptoms due to unstable electricity) in the facility will occur later, and facility maintenance may be performed by providing the expected movement and time for the corresponding dot group to the manager terminal 300.

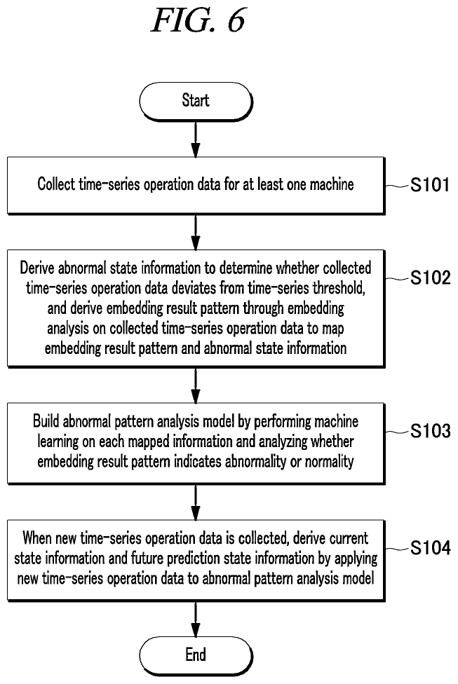

Hereinafter, with reference to FIG. 6, a description will be given of a sequence of performing the embedding analysis-based facility predictive maintenance method according to an example embodiment of the present disclosure.

First, the server 100 collects time-series operation data 500 for at least one machine S101.

Thereafter, the abnormal state information is derived to determine whether the collected time-series operation data 500 deviates from the time-series threshold, and the embedding result pattern 600 is derived through embedding analysis on the collected time-series operation data 500 to map the embedding result pattern 600 and abnormal state information S102.

Next, an abnormal pattern analysis model is built by performing machine learning on each mapped information and analyzing whether the embedding result pattern 600 indicates abnormality or normality S103.

When the new time-series operation data 500 is collected, the server 100 applies the new time-series operation data 500 to the abnormal pattern analysis model to derive current state information and future prediction state information S104.

An example embodiment of the present disclosure may also be implemented in the form of a recording medium including instructions executable by a computer, such as a program module executed by a computer. Computer-readable media may be any available media that may be accessed by a computer and includes both volatile and nonvolatile media, removable and non-removable media. In addition, computer-readable media may include all computer storage media. Computer storage media includes both volatile and nonvolatile, removable and non-removable media implemented in any method or technology for storage of information such as computer readable instructions, data structures, program modules or other data.

Although the methods and systems of the present disclosure have been described with reference to specific example embodiments, some or all of their components or operations may be implemented using a computer system having a general-purpose hardware architecture.

The example embodiments disclosed in the present specification are intended merely to present specific examples, and it will be apparent to those skilled in the art that the present disclosure can be easily modified into other specific forms without changing the technical spirit or essential features of the present disclosure. Therefore, it should be understood that the example embodiments described above are illustrative in all respects and not restrictive. For example, each component described as a single type may be implemented in a distributed manner, and likewise components described as distributed may also be implemented in a combined form.

Therefore, the scope of the disclosure is defined not by the detailed description, but by the claims and their equivalents, and all variations within the scope of the claims and their equivalents are to be construed as being included in the disclosure.

<Explanation of Symbols>

| | |
|---|---|
| 100: Server | 200: IoT sensor |
| 300: Manager terminal | 400: Motion data |
| 500: Time-series operation data | 600: Embedding result pattern |
| 601: First group dots | 602: Second group dots |
| 603: Third group dots | |

What is claimed is:

1. An embedding analysis-based facility predictive maintenance method performed by a server, comprising:
(a) collecting time-series operation data of at least one machine;
(b) deriving abnormal state information to determine whether the collected time-series operation data deviates from a time-series threshold, deriving an embedding result pattern through embedding analysis on the collected time-series operation data, and mapping the embedding result pattern and the abnormal state information;
(c) building an abnormal pattern analysis model by performing machine learning on each mapped information and analyzing whether the embedding result pattern indicates abnormality or normality; and
(d) when new time-series operation data is collected, applying the new time-series operation data to the abnormal pattern analysis model to derive current state information and future prediction state information.

2. The embedding analysis-based facility predictive maintenance method according to claim 1, wherein the (a) comprises:
(a-1) collecting operation data when the machine operates and performs a process of manufacturing a specified product;
(a-2) converting the operation data into frequency data by performing FFT analysis; and
(a-3) dividing the collected operation data by using time required for the machine to manufacture one product as one cycle, and collecting the time-series operation data by mapping the divided operation data on a time domain having a length corresponding to the one cycle.

3. The embedding analysis-based facility predictive maintenance method according to claim 2, wherein when there are a plurality of measurement sensors installed in the machine, the operation data is data related to an operation of the machine collected by each of a plurality of channels for a preset period from an IoT sensor.

4. The embedding analysis-based facility predictive maintenance method according to claim 1, wherein the (b) comprises:
(b-1) deriving upper and lower limits of the time-series threshold by learning time-series operation data from which actual state information is generated and time-series operation data indicating a normal state;
(b-2) detecting abnormal state information of real-time time-series operation data according to whether the collected time-series operation data deviates from the upper and lower limits of the time-series threshold;
(b-3) deriving the embedding result pattern by embedding analysis of the time-series operation data; and
(b-4) matching and storing the abnormal state information, the embedding result pattern, and the actual state information of the time-series operation data,
wherein the actual state information is information indicating whether there is a machine error and whether a product manufactured by the machine is defective, which is any one of information indicating machine error and product defect, information indicating machine error and product normality, and information indicating machine normality and product defect.

5. The embedding analysis-based facility predictive maintenance method according to claim 4, wherein the embedding result pattern is expressed as a graph consisting of four quadrants, and
wherein in the graph, any one of an X-axis and a Y-axis indicates a presence or absence of an abnormal state, the other indicates a degree of the abnormal state, and a result value of FFT analysis of the operation data is displayed as dots of different colors for each three-phase channel.

6. The embedding analysis-based facility predictive maintenance method according to claim 5, wherein the dots comprises first group dots distributed sporadically over a preset interval and second group dots distributed close to each other within the preset interval or less, and the server detects the presence or absence of the abnormal state and the degree of the abnormal state based on which quadrant the second group dots are located.

7. The embedding analysis-based facility predictive maintenance method according to claim 4, wherein the (b-3) comprises:
matching and storing the abnormal state information, the embedding result pattern, and the actual state information of a specific machine from a normal state to an abnormal state or until returning to the normal state after a failure state occurs, and performing machine learning.

8. The embedding analysis-based facility predictive maintenance method according to claim 1, wherein the (b) further comprises:
predicting a future embedding result pattern from the embedding result pattern by the time-series operation data collected in real-time based on the result of the machine learning performed in the (b-3).

9. The embedding analysis-based facility predictive maintenance method according to claim 8, wherein the future embedding result pattern is related to a movement direction, movement distance, and movement time of each dot group forming the current embedding result pattern.

10. The embedding analysis-based facility predictive maintenance method according to claim 8, wherein the future embedding result pattern is related to a presence or absence of a failure or abnormal state, and time taken until normal operation after the failure or abnormal state occurs.

11. The embedding analysis-based facility predictive maintenance method according to claim 1, wherein the (b) further comprises:
updating the time-series threshold as the operation data is collected and accumulated in real-time.

12. The embedding analysis-based facility predictive maintenance method according to claim 1, further comprising:
(e) providing a manager terminal with prediction information on whether an operating state of the machine will change from a normal state to an abnormal state or a prediction information on whether the operating state of the machine will change from the abnormal state to the normal state and the future prediction state information and actual state information including information on a type of failure and time required for each state transition.

13. A server performing an embedding analysis-based facility predictive maintenance method, comprising:
a memory in which a program configured to perform an embedding analysis-based facility predictive maintenance method is stored; and
a processor configured to execute the program,
wherein the method comprises:
(a) collecting time-series operation data of at least one machine;
(b) deriving abnormal state information to determine whether the collected time-series operation data deviates from a time-series threshold, deriving an embedding result pattern through embedding analysis on the collected time-series operation data, and mapping the embedding result pattern and the abnormal state information;
(c) building an abnormal pattern analysis model by performing machine learning on each mapped information and analyzing whether the embedding result pattern indicates abnormality or normality; and
(d) when new time-series operation data is collected, applying the new time-series operation data to the abnormal pattern analysis model to derive current state information and future prediction state information.
